(19) United States
(12) Patent Application Publication
(10) Pub. No.: US 2021/0274374 A1
(43) Pub. Date: Sep. 2, 2021

(54) METHOD AND NETWORK NODE FOR SUPPORTING A SERVICE OVER A RADIO BEARER

(71) Applicant: Telefonaktiebolaget LM Ericsson (publ), Stockholm (SE)

(72) Inventors: Ola LUNDQVIST, Karlstad (SE); Niklas JOHANSSON, Uppsala (SE); Anders K. ERIKSSON, Uppsala (SE)

(21) Appl. No.: 17/254,873

(22) PCT Filed: Jun. 25, 2018
(86) PCT No.: PCT/SE2018/050679

§ 371 Date: Dec. 22, 2020

(51) Int. Cl. H04W 28/02; H04L 1/18

(52) U.S. Cl. CPC H04W 28/0236; H04L 1/1819; H04W 28/0268; H04W 28/0252

(57) ABSTRACT

A method and a network node for supporting a service over a radio bearer to a device, involving use of alternative priorities in relation to an estimated radio quality, are disclosed. The radio bearer is associated with a QoS and said device being of a device category that is admitted restricted use of transmission resources on a radio interface between the network node and the device. The method involves applying a first priority, and that is associated with the QoS, to the radio bearer when an estimated quality on the radio interface is at least as good as first level, and applying a second priority, lower than the first priority, to the radio bearer when the estimated quality of the radio interface is less good than said first level.

### TECHNICAL FIELD

The technology presented relates to a method and a network node for supporting a service over a radio bearer to a device, involving use of alternative priorities in relation to an estimated radio quality.

### BACKGROUND

The 3GPP is standardizing devices of types that are of low complexity intended for the IoT, and with corresponding access technologies within the cellular radio access technologies. On example is Machine-Type Communications (MTC) for E-UTRA release 13, LTE, with the corresponding low complexity UE, Category Machine, Cat-M device and that is restricted to operate within a 1.4 MHz bandwidth. The Cat-M device further operates on a transmit power that is considerable lower, has reduced support for downlink transmission modes, and ultra-long battery life via power consumption reduction techniques as compared to legacy devices. Cat-NB1 and Cat-NB2 are LTE categories of devices referred to as Narrowband IoT, and that are restricted to operate on a 180 KHz bandwidth and also are arranged for operating at reduced power for long battery life. By categorizing the different types of UEs having a bandwidth, a power etc. that are restricted as compared to that of conventional UEs, the network can better support the communication with these devices. For example, the Cat-M access also defines that the network shall support the communication with the Cat-M devices by configuring them with coverage extension. In coverage extension a data packet is sent over the radio interface in a predefined number of transmissions. The data is the same but coded differently in the repetitions. The receiver combines retransmitted replicas of the packet by soft-combining. The receiver can then decode the data also when the transmit power is low and the received signal is exposed to interference. While coverage extension is mandatory for the Cat-M devices, it can optionally be configured also for other categories of devices.

Also for the 2G, Edge/GSM system there is a device category, EC-GSM-IoT, intended for the IoT. It can be expected that further categories of low complexity UEs, will be defined for the LTE, as well as for other generations of radio communication network, such as the 3G, UTRA, and the 5G New Radio, NR systems.

Although the CAT-M, and Narrowband IoT categories of devices are intended to be at low cost and at low battery consumption, there is yet a need for advanced services to these devices such as VoIP and video. VoIP and video may require transportation of high data rates while they also have a limited delay budget for the data transportation between the use/server end points. These types of services are therefore given priority over other types of services when devices are scheduled for transmission over the radio link. A problem is thought that the VoIP or video service may consume most of the restricted resources available on the radio interface to be shared by the specific category of devices. The restriction may be in the frequency bandwidth on the radio interface and may relate to use of a restricted set of the available transmission time intervals. The resource consumed by a single device can prevent services to other devices. An example is a device that is configured with coverage extension and being involved in VoIP or video service, when the data despite the predefined number of transmission is not detected at the receiver HARQ-retransmission are made on top of the predefined transmissions. The service may then for a period consume the bandwidth that is intended to be shared among the devices. A voice or video service is typically released when its QoS requirement cannot be provided by the network and a new VoIP or video session may be denied when network estimates it cannot meeting the QoS requirement. That policy is however not well fitted for the devices of categories having a limited access to the network resources.

### SUMMARY

Accordingly, one objective of the technology presented is to support a service such as VoIP and video to a device of a category that shares with devices of the same category a restricted set of resources for transmission on the radio interface, while also avoiding that other devices of the same category are denied communication service.

In a first aspect there is provided a method for a network node of supporting a service over a radio bearer to a device, said radio bearer being associated with a Quality of Service, QoS and said device being of a device category that is admitted restricted use of transmission resources on a radio interface between the network node and the device. The method comprising, applying a first priority, and that is associated with the QoS, to the radio bearer when an estimated quality on the radio interface is at least as good as first level, and applying a second priority, lower than the first priority, to the radio bearer when the estimated quality of the radio interface is less good than said first level.

In another aspect of the technology there is provided a network node that is supporting a service over a radio bearer to a device, said radio bearer being associated with a QoS and said device being of a device category that is admitted restricted use of transmission resources on a radio interface between the network node and the device. The network node is further arranged to apply a first priority, and that is associated with the QoS, to the radio bearer when an estimated quality on the radio interface is at least as good as first level, and apply a second priority, lower than the first priority, to the radio bearer when the estimated quality of the radio interface is less good than said first level.

### BRIEF DESCRIPTION OF THE DRAWINGS

FIG. 1; is a view of the nodes in a radio communication system.

FIG. 2; is a time frequency plane, illustrating the location of different frequency bands.

FIG. 3; is a time and frequency grid, illustrating physical resources on the radio interface for an LTE OFDM system.

FIG. 4; is a stack of protocols in the LTE system.

FIGS. 5 and 6; are flowcharts of respective methods.

FIG. 7; is a block diagram of a network node.

### DETAILED DESCRIPTION

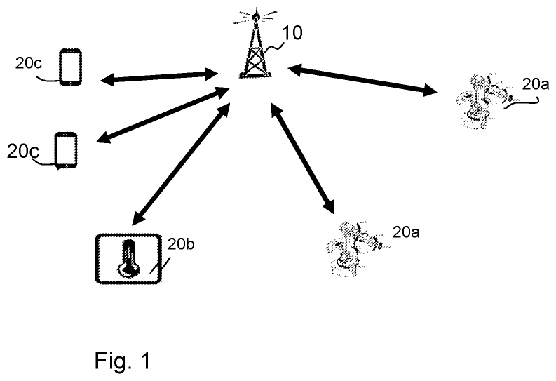

FIG. 1 is a view of a network node, 10, that provides communication service over a radio interface with a number of devices, 20. The devices, 20, are of different categories and comprise Cat-M devices 20a, Narrowband IoT devices 20b, and also other devices 20c. The network node, 10 supports the communication with the Cat-M devices 20a, and the Narrowband IoT devices 20b, on a respective bandwidth on the radio interface that is restricted as compared to the bandwidth that non-IoT devices 20c, may use. The network node 10, may further support the communication with the Cat-M devices 20a, and the Narrowband IoT devices 20b, to use any of, a reduced transmit power, a reduced support for downlink transmission modes, and reduced power consumption enabling ultra-long battery. Reduced is here compared to that used by a non-IoT device 20c. The Cat-M devices 20a, are restricted to operate within a 1.4 MHz frequency bandwidth that the network provides for the devices. The Cat-M devices 20a are also arranged for coverage extension and that by use of repetitive transmissions of the same data improves coverage with up to 15 dB. The Narrowband IoT devices, 20b, comprising the Cat-NB1 and Cat-NB2 categories have their bandwidth capability restricted to 180 kHz. The Cat-M and the Narrowband IoT devices are limited to transmit at a maximum power of 23 dBm. The Narrowband IoT devices are further restricted to use just a single carrier while the more advance devices 20c, may be configured with carrier aggregation or dual connectivity and then use several frequency carriers.

The categories of devices as are defined in 3GPP release 13, enables the network to better support the communication with these devices. It can also be expected that further categories will be defined also in the future for example in the 5G, New Radio, NR.

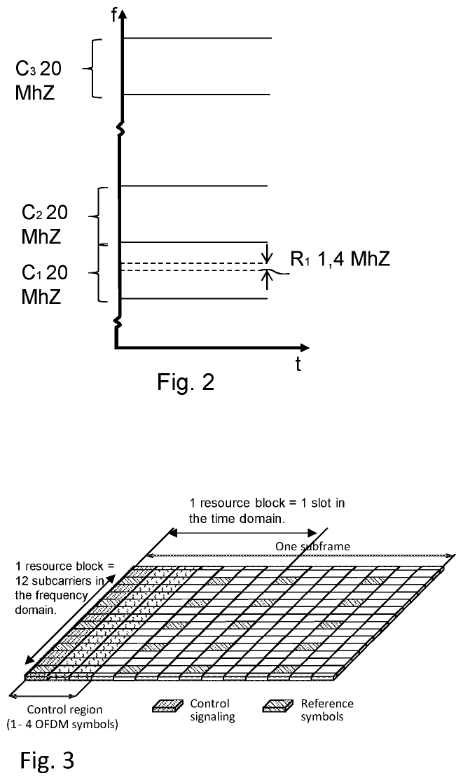

FIG. 2 illustrates along a vertical axis the frequency spectrum and the different bands that may be assigned for communication by some public networks. R₁ illustrates a 1.4 MHz band that the Cat-M devices 20a, shares. C₁, C₂ and C₂ are 20 MHz carriers that are available for other types of devices 20c. The 1.4 MHz band, R₁, may be assigned within any of the 20 Mhz carriers, C₁, C₂ and C₂, as is depicted in FIG. 2 and may then be shared also by devices 20c, of other categories than Cat-M, while it may alternatively be assigned outside any of the 20 MHz carriers C₁, C₂ and C₂, and then be shared just by the Cat-M devices, 20a.

FIG. 3 illustrates the OFDM time frequency grid in the LTE system, with time represented at the horizontal axis and frequency along the other axis. An LTE resource block comprises 12 sub-carriers in the frequency domain and one slot of typically 7 OFDM symbols in the time domain. In LTE data is transmitted over a shared channel, in respectively the uplink, UL, and the downlink, DL. Devices 20, that have data buffered for transmission are, based on the priority of the service they are involved in, scheduled resources on the shared channel. Scheduling is made per 1 ms basis for legacy devices 20, Cat-M devices 20a, and Narrowband IoT devices 20b. A device is then scheduled a flexible number of resource blocks in the frequency domain, and in the time domain a 1 ms period of 2 resources blocks referred to as a Transmission Time Intercall, TTI. The scheduled resources are granted to the devices 20, for transmission in the uplink UL direction or assigned for receiving in the downlink DL. Resources less than 1 ms, and referred to as a short TTI, may be scheduled to advanced devices 20 of release 13. Also in NR, the data channels are shared and scheduled to the devices 20 based on the priority of the service the device is involved in, while there is some more flexibility in the size of the resources scheduled.

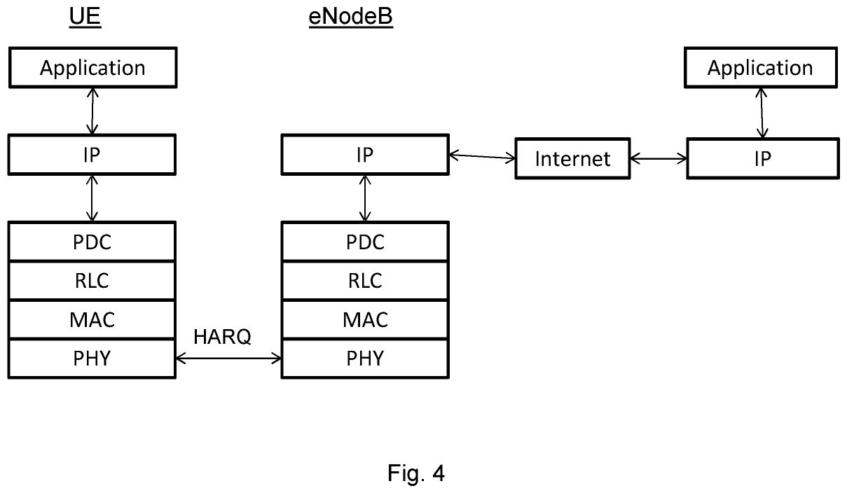

FIG. 4 depicts an LTE protocol stack in the device 20 that is here represented by the LTE UE and in a network node, 10, that here is represented by the eNodeB. At the top there is an application layer between the UE and a server in the internet or a peer device, 20. Under the application layer there is an IP layer that provides a communication bearer between the UE and the server or peer device 20, and tunnels the data of the application layer between these entities. To establish an IP bearer in the LTE network over the core network for connecting to the outside web, an EPC core network establishes a radio bearer. It is typically the MME that establishes the radio bearer between the MME via the eNodeB to the UE/device 20. The MME/EPC core network node then also assigns a Quality-of-Service, QoS, class identifier, QCI, to the radio bearer. The QoS is associated with the specific service of the IP layer, and that for example may be VoIP, Video or an IP based service such as e-mail or chat. The QCI derives from the QoS and includes a priority of the radio bearer, and that is used for determining if the radio bearer, in competition with other radio bearers, should be assigned shared transmission resources.

The radio bearer is further supported by the Packet Data Convergence Protocol, PDCP layer in the UE and in the eNodeB for the transmission of data over the radio interface. The QCI, that associated with the respective radio bearer is provided by the PDCP via the Radio Link Control, RLC layer to the Medium Access Control, MAC, layer. The MAC layer is the focus for the technology here presented. The MAC layer handles scheduling of resources on the radio interface to the devices. MAC use the priority that is included in the QCI of the radio bearer, and schedules resources to the different devices, 20, based on the priority of their respective radio bearer. When two or more devices have data to transmit, and the capacity of the air interface does not admit for all to be scheduled, the one/s with higher priority than other is/are scheduled for transmission on the radio interface. At the bottom of the stack, the physical layer, PHY, handles physical adaption of the signals for transmission over the radio interface.

In the technology claimed, a priority other than that prescribed by the QoS may be applied by the scheduler under certain circumstances as will be further presented.

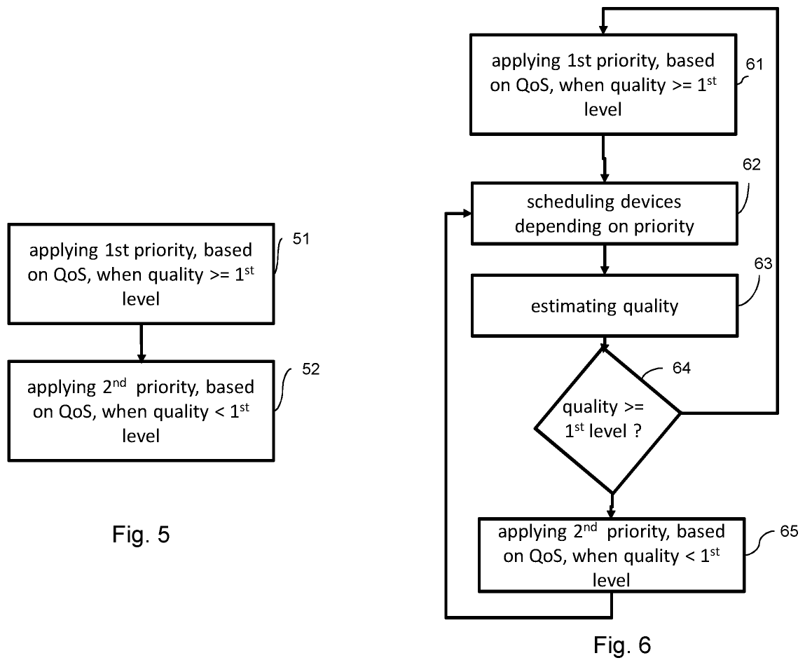

In FIG. 5 is depicted the steps of a method for a network node for providing a service over a radio bearer to a device 20. In a first step, 51, a priority based on the QoS associated with the radio bearer is applied by the network node 10 when an estimated quality of the radio interface between the network node 10 and the device 20 is at least as good as a first quality. In a second step, 52, a second priority, lower than the first priority is applied when the estimated quality of the radio interface is less good than the first quality.

This means that when the quality on the radio interface becomes less good than the first quality, the priority of the radio bearer is decreased, and the chances of the radio bearer being scheduled shared resources on the radio interface decreases as compared to when the quality meets or exceeds the first level. Thereby the network node 10, may schedule resources also to devices 20a, 20b that otherwise would have been consumed by a radio bearer of a high priority service such as VoIP or video, and that by traditional priority assignment could consume most of the physical radio resources on a shared frequency carrier and thereby prevent other devices 20 from being scheduled. When the radio environment of the high prioritized devices 20a, 20b is good, the data transmission can be fast and the less prioritized devices 20a, 20b, may be scheduled after a voice burst of a VoIP bearer has been transmitted. When a Cat-M device 20a, or another category of Narrowband IoT device 20b, with a high prioritized radio bearer is exposed to less good radio environment the restricted bandwidth can be occupied for a period and prevent communication with other devices, 20a, 20b. If the device is also configured with coverage extension, as is always the case for the Cat-M devices 20a, there is a predefined number of transmissions, spanning 4-32, of the same data packet. When the data packet, despite the predefined number of transmissions, cannot be detected at the receiver HARQ retransmissions are triggered and the restricted bandwidth available to the class of devices, 20a, 20b can be consumed by a single device 20a, 20b for a longer period. If the limitation relates to a restricted set of transmission time intervals to be shared by a category of devices, 20a, 20b, also these may be consumed by a single device, 20a. Reducing the number of predefined retransmission would not help the situation, as further HARQ-retransmissions would be triggered and continue to occupy the bandwidth or time slots or both.

In HARQ just as in coverage extension a receiver temporarily stores an erroneously received data packet and combines it with one or more later received replicas of that packet. Such replicas contain the same data as the previous packet but with different encoding. The decoding by combining several received packets is referred to as soft combining. In coverage extension the number of retransmission are predefined, whereas HARQ retransmission is triggered by feedback from the receiver.

The decrease of the priority for the radio bearer when the radio interface quality deteriorates below the first level, as is performed in step 52, has the advantage of also other radio bearers may be scheduled over the radio link.

In emergency situations maintenance of service is more important than providing the service at the right quality level. The network including the network node 10, is informed of the device being in an emergency situation by, for example, an information element that is provided by the device during the LTE random access procedure. Moreover, also if the service is interrupted for a period of some seconds up to some minute, by keeping the radio bearer the service can be re-established faster when the radio environment becomes better than if the radio bearer had been torn downed. In an alternative embodiment, a further condition for providing a second priority to the device when the quality on the radio interface of the radio bearer is below the first level, is that the device is in an emergency situation. If not, the radio bearer is released when the radio link quality does not reach the first level.

While the priority applied in the first step 51, is based on the QoS that is associated with the radio bearer the second priority applied in the second step 52 may be determined by the network node 10 itself. Alternatively, in a scenario where many of the network controlling functions reside in servers distributed over an IP network, such as is often referred to as The Cloud, the network node may comprise basic hardware and only some control functions including radio link adaption and scheduling, and the priority as applied in the first and second steps 51, 52 may then be provided to the network node, 10, from some external entity.

FIG. 6 discloses an embodiment of the method disclosed in FIG. 5. In the first step, 61, the network is applying a first priority for a radio bearer, based on the QoS that is associated with the radio bearer, and when the quality on the radio interface between the device 20a, 20b meets or is better than a first quality level. A condition for setting up a radio bearer may be that the estimated quality on the radio interface meats or increases a predefined level, for example the first level. The quality is however difficult to estimate based only on the short initial signalling before the radio bearer is established, and the quality may show to be poorer than estimated when the radio bearer has been established and data is being transmitted. In next step the network node schedules 62, resources on the radio interface depending on the priority of the respective radio bearer that have data buffered for transmission. The scheduling 62, is made independently for respectively the UL and the DL based on the priority and amount of data buffered. In the step following 63, the quality of the radio interface between the device 20a, 20b, and the network node of radio bearer is estimated and compared, step 64, to the first level, and if the estimated quality is at least as good as the first level the first priority continues to be applied 61, in the first step and used in the following step of scheduling 62. If, however, the estimated quality of the radio interface does not meet the first level, a second priority is applied 65 in the first step is and then used in the following step of scheduling 62. The process continues from step 62 in a loop.

As an alternative of determining which of the first and second priority to apply to the radio bearer, the network node may receive any of these priorities from an external node and with an instruction to apply it to the radio bearer. In this alternative the network node 10 would provide information relating to the radio link quality such that it may be estimated by the external node and the priority of the radio bearer be determined externally.

When the radio bearer has been established the estimation of its radio interface quality is based on measurements at the receiving side of the device 20a, 20b, or the network node or both. There are alternatives for how the estimating, 63, of the radio quality is made. In one alternative the radio quality is estimated based on one or more of the following parameters:
the Channel Quality Indicator, CQI, as is a report of the DL radio channel quality received from the device 10
the quote of Ack/Nack HARQ reports as received from the UE or sent to the UE
the failure in receiving expected HARQ reports from the UE and failure in receiving data in UL resource blocks that have been granted for UL transmission
measures of the signal-to-interference-plus-noise ratio and SIR
the power of a DL reference signal as measured and reported by the device 20a, 20b or the power of a device specific UL reference signal as measured by the network node

In an alternative embodiment one or more of the above parameters are used for estimating a data throughput of the radio bearer over the radio interface, and the estimated data throughput is used as the radio link quality that is used for comparing to the first quality level in steps 52 and 64. In a FDD based system, the estimation of the UL quality is made separately of the DL quality estimation. In yet an alternative embodiment, the radio interface quality is estimated based on throughput. Throughput might be determined based on bits per second delivered to a specific on the layers in the stack, or it may be determined based the number of data packets correctly detected over a time versus the amount of physical radio resources consumed for its transmission. The data packets may then be MAC packet data units, PDUs, or PHY Transport blocks. The physical resources may be the number of OFDM resource blocks used for the data packet transmission and may also be the energy used for the transmission.

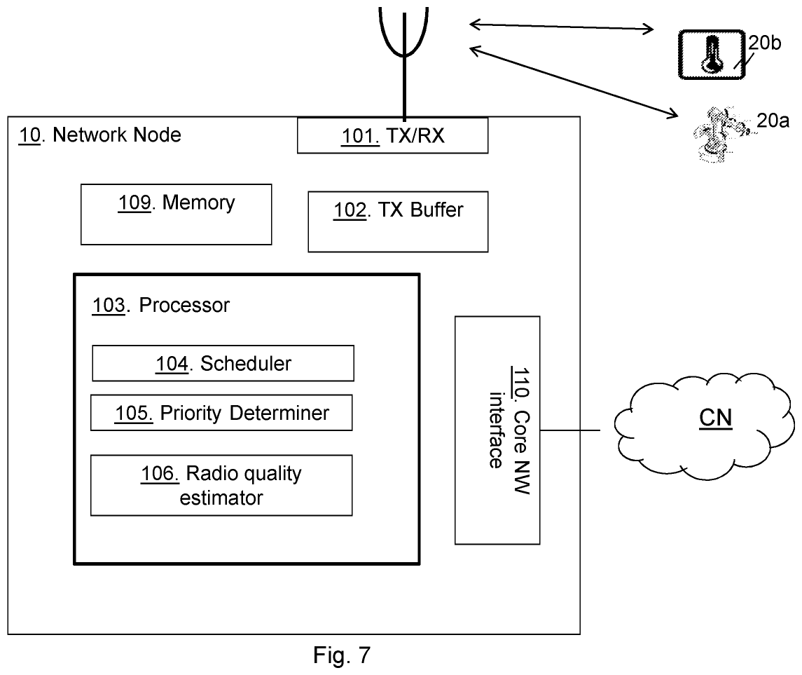

FIG. 7 is a block diagram of a network node 10, and to ease the understanding of the technology claimed only those parts relevant to its features and embodiments are illustrated. The network node 10, comprises a transceiver 101, for transmitting and receiving radio bearers via an antenna over the radio interface, a transmit buffer 102, a scheduler 104, an optional priority determiner 105, a radio quality estimator 106, a processor 103, a memory 109 and a core network interface 110. The network node 10, is arranged to support the communication over radio bearers that are set up between one or more devices 20, and the core network via the core network interface 110, and via the transceiver 101. Downlink data of the respective radio bearer is received from the core network interface 110, and provided to the transmit buffer 102, for DL transmission via the transceiver to the respective device 20. The transmit buffer 102, may buffer packet data units PDUs of the respective radio bearer as are received from the MAC protocol layer, see FIG. 4. The scheduler 104, is arranged to schedule resources on the shared DL channel to the radio bearers based on their respective amount of data in the transmit buffer 102, and based on the priority of the respective radio bearer. The scheduler 104, also schedules the UL transmissions, triggered by scheduling requests received from the devices, and based on the respective radio bearer priority. The scheduler 104, is further arranged to schedule a predefined number of transmissions of the same data for devices that are configured with coverage extension. The scheduler 104, is also arranged to schedule Cat-M and Narrowband IoT devices in a respective frequency sub-band having a restricted bandwidth. For a category of devices that have a limitation in what transmission time intervals they may use, the scheduler is configured to schedule only admitted transmission time intervals to these devices.

The radio quality estimator 106, estimates for each access bearer the quality on the radio interface between the network node 10, and respective of the devices 20. The estimation is performed as is described in relation to FIG. 6. The radio quality estimator 106 receives from the transceiver 101, parameters measured in the UL and in case of TDD also received DL quality indicators reported from the respective device 20a, 20b. These types of parameters are conventionally used for link adaptation while they may also be used for determining the priority of a radio bearer.

The network node 10, is arranged to, when supporting a service over a radio bearer to a device, 20a, 20b, apply a first priority to the radio bearer that is associated with the QoS of the radio bearer, when an estimated quality on the radio interface of the radio bearer is at least as good as a first level, and apply a second priority to the radio bearer, lower than the first priority, when the estimated quality is less good than the first level.

Either of the first and the second priority is applied by the scheduler 104, when scheduling resources on the radio interface to the radio bearer. In one embodiment, the network node 10, comprises a priority determiner 105, that is arranged to determine the priority based on the QoS as is received from layers above that of the MAC in the LTE protocol stack, and based on the estimated radio quality of the radio bearer, as is received from the radio quality estimator 106. The priority determiner 105, provides the priority for the radio bearer to the scheduler. Alternatively, the priority is determined external of the network node, 10, based on quality measures received from the network node, 10, and then provided to the network node for used by the scheduler 104.

The operation of the scheduler 104, the priority determiner 105, and the radio quality estimator 106, is controlled by a processor 103. The processor comprises processing circuitry and that may include any form of processing component, including dedicated microprocessors, general-purpose computers, or other devices capable of processing electronic information. Examples of processor 103, include field-programmable gate arrays (FPGAs), programmable microprocessors, digital signal processors (DSPs), application-specific integrated circuits (ASICs), and any other suitable specific- or general-purpose processors. Although FIG. 7 illustrates, for the sake of simplicity, an embodiment that includes a single processor 103, that enables the operation of the scheduler 104, the priority determiner 105, and the radio quality estimator 106, there may be any number of processors 103, configured to interoperate and be grouped for primarily serving some respective of the scheduler 104, the priority determiner 105, and the radio quality estimator 106. In particular embodiments, some or all of the functions provided by the scheduler 104, the priority determiner 105, and the radio quality estimator 106 described above may be implemented by processor 103, executing instructions received from memory 109, and/or operating in accordance with its hardwired logic.

The memory, 109, stores processor instructions, equation parameters, resource allocations, and/or any other data utilized by the scheduler 104, the priority determiner 105, and the radio quality estimator 106, during operation. The processor 103, running instructions from Memory 109, is also configured to receive from protocol layers above the MA, QoS parameters for the respective radio bearer including a priority associated with the radio bearer. Memory 109, may comprise any collection and arrangement of volatile or non-volatile, local or remote units suitable for storing data, such as random access memory (RAM), read only memory (ROM), magnetic storage, optical storage, or any other suitable type of data storage components. Although shown as a single element in FIG. 7, memory 109, may include one or more physical components.

Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural and vice versa.

Numerals included within parentheses in the accompanying claims are intended to assist understanding of the claims and should not be construed in any way to limit subject matter claimed by these claims.

1. A method in a network node for supporting a service over a radio bearer to a device, said radio bearer being associated with a QoS and said device being of a device category that is admitted restricted use of transmission resources on a radio interface between the network node and the device, said method comprising,
applying a first priority, and that is associated with the QoS, to the radio bearer when an estimated quality of the radio interface is at least as good as first level, and,
applying a second priority, lower than the first priority, to the radio bearer when the estimated quality of the radio interface is less good than said first level.

2. The method according to claim 1, comprising the further step of scheduling shared resources on the radio interface to said radio bearer and one or more further radio bearers depending on their respective priority.

3. The method according to claim 1, wherein the estimated quality on the radio interface is an estimated data throughput.

4. The method according to claim 1, comprising the further step of estimating the radio interface quality based on one or more of the parameters, CQI as reported by the device, HARQ responses received from the device, failure in receiving expected HARQ responses from the device, measured power of a reference signal, SINR and SIR.

5. The method according to claim 3, wherein the data throughput is estimated based on one or more of the parameters CQI as reported by the device, HARQ responses received from the device, failure in receiving expected HARQ responses from the device, measured power of a reference signal, SINR and SIR.

6. The method according to claim 1, wherein the device category is any of CAT-M, and Narrow Band IoT.

7. The method according to claim 1, wherein the restricted use of transmission resources that is admitted to the device category, relates to at least one of a restriction in the maximum frequency bandwidth, restriction in length of transmission time intervals and a restriction on the maximum UL power.

8. The method according to claim 1, wherein the restricted use of transmission resources further involves a predefined number of repeated data transmissions.

9. The method according to claim 1, wherein the service is VoIP, Video or streaming Video.

10. The method according to claim 1, wherein a further requirement for assigning the second priority to the radio bearer, is that the device is in an emergency situation.

11. The method according to claim 10, wherein the radio bearer is released when the quality of the radio interface is less good than said first level and the device is not in an emergency situation.

12. A network node arranged for supporting a service over a radio bearer to a device, said radio bearer being associated with a QoS and said device being of a device category that is admitted restricted use of transmission resources on a radio interface between the network node and the device, and further being arranged to:
apply a first priority, and that is associated with the QoS, to the radio bearer when an estimated quality of the radio interface is at least as good as first level, and,
apply a second priority, lower than the first priority, to the radio bearer when the estimated quality of the radio interface is less good than said first level.

13. The network node according to claim 12, comprising a priority determiner arranged to determine which one of the first priority or the second priority to apply based on the QoS of the radio bearer and based on said estimated quality on the radio interface.

14. The network node according to claim 12, further comprising a scheduler arranged to schedule shared resources on the radio interface to said radio bearer and one or more further radio bearers depending on their respective priority.

15. The network node according to claim 12, comprising a radio quality estimator arranged to estimate the radio interface quality based on one or more of parameters, CQI as reported by the device, HARQ responses received from the device, failure in receiving expected HARQ responses from the device, measured power of a reference signal, SINR and SIR.

16. The network node according to claim 15, wherein said estimated quality on the radio interface is an estimated data throughput and said radio quality estimator further is arranged to estimate said data throughput based on any of parameters CQI as reported by the device, HARQ responses received from the device, failure in receiving expected HARQ responses from the device, measured power of a reference signal, SINR and SIR.

17. The network node according to claim 12, wherein the device category is any of CAT-M, and Narrow Band IoT.

18. The network node according to claim 12, wherein the restricted use of transmission resources that is admitted to the device category, relates to at least one of a restriction in the maximum frequency bandwidth, restriction in length of transmission time intervals and a restriction on the maximum UL power.

19. The network node according to claim 12, wherein the restricted use of transmission resources further involves a predefined number of repeated data transmissions.

20-22. (canceled)

23. The network node according to claim 12, comprising a processing circuitry and a memory containing software that when run on the processor causes the network node to:
assign the first priority, and that is associated with the QoS, to the radio bearer when an estimated quality on the radio interface is at least as good as first level, and
assign the second priority, lower than the first priority, to the radio bearer when the estimated quality of the radio interface is less good than said first level.
